(19) United States
(12) Patent Application Publication
(10) Pub. No.: US 2026/0330321 A1
(43) Pub. Date: Oct. 22, 2026

(54) MACHINE LEARNING APPARATUS AND INFERENCE APPARATUS

(71) Applicant: JVCKENWOOD Corporation, Yokohama-shi (JP)

(72) Inventor: Toshihide KOBAYASHI, Yokohama-shi (JP)

(21) Appl. No.: 19/706,264

(22) Filed: Jun. 12, 2026

Related U.S. Application Data
(63) Continuation of application No. PCT/JP2024/035432, filed on Oct. 3, 2024.

(30) Foreign Application Priority Data
Dec. 19, 2023 (JP) 2023-213803
Dec. 19, 2023 (JP) 2023-213804

(51) Int. Cl. G06N 20/00; G06T 7/20

(52) U.S. Cl. CPC G06N 20/00; G06T 7/20; G06T 2207/20081

(57) ABSTRACT

A first acquisition unit acquires first training images of two frames of a subject captured by a first image sensor. A second acquisition unit acquires a three-dimensional training motion vector derived based on second training images of two frames of the subject captured by a second image sensor of a type different from that of the first image sensor at the same point of time as the first training images of the two frames. A learning unit receives the first training images of the two frames acquired as an input, and trains a model by machine learning using the training motion vector acquired as a correct vector.

### CROSS-REFERENCE TO RELATED APPLICATION

This application is a continuation of application No. PCT/JP2024/035432, filed on Oct. 3, 2024, and claims the benefit of priority from the prior Japanese Patent Applications No. 2023-213803, filed on Dec. 19, 2023 and No. 2023-213804, filed on Dec. 19, 2023, the entire contents of which are incorporated herein by reference.

### BACKGROUND

### 1. Field

The present disclosure relates to a machine learning apparatus and an inference apparatus.

### 2. Description of the Related Art

In recent years, various technologies that use images taken by cameras have been developed. Patent literature 1 discloses a person detection system equipped with an RGB camera and a ToF (Time of Flight) sensor.
[Patent literature 1] JP2021-76948

SLAM (Simultaneous Localization and Mapping) is known for its use in autonomous driving technology for moving objects such as robots. One of the SLAM technologies is a technology called visual SLAM (hereinafter referred to as VSLAM). VSLAM periodically acquires a motion vector between images of two frames captured by an RGB sensor or a monochrome sensor and periodically estimates a self-location and creates a map based on the motion vector. VSLAM can be implemented by using relatively low-cost RGB or monochrome sensors, which makes it easy to control product costs.

Generally, however, a false motion vector is easily acquired and a lost self-location easily occurs in VSLAM in the case a major portion of the imaged subject is a wall and there are few feature points on the wall.

### SUMMARY

A machine learning apparatus according to an embodiment includes: a first acquisition unit that acquires first training images of two frames of a subject captured by a first image sensor; a second acquisition unit that acquires a three-dimensional training motion vector derived based on second training images of two frames of the subject captured by a second image sensor of a type different from that of the first image sensor at the same point of time as the first training images of the two frames; and a learning unit that receives the first training images of the two frames acquired as an input, and trains a model by machine learning using the training motion vector acquired as a correct vector. The first training images are non-polarization images, and the second training images are polarization images.

Another aspect of the embodiment relates to an inference apparatus. The apparatus includes: an acquisition unit that acquires images of two frames captured by the first image sensor; and an inference unit that uses a trained model to infer a three-dimensional motion vector based on the images of the two frames acquired. The trained model is trained by machine learning based on: first training images of two frames of a subject captured by an image sensor of the same type as the first image sensor; and a three-dimensional training motion vector derived based on second training images of two frames of the subject captured by a second image sensor of a type different from that of the first image sensor. The first training images are non-polarization images, and the second training images are polarization images.

Optional combinations of the aforementioned constituting elements, and implementations of the embodiments in the form of methods, apparatuses, systems, recording mediums, and computer programs may also be practiced as modes of the embodiments.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a block diagram schematically showing a configuration of the training data creation apparatus according to the first embodiment;

FIG. 2 shows an example of a method to derive a motion vector from an RGB image;

FIG. 3 shows an example of a method to derive a motion vector from a distance image;

FIG. 4 is a block diagram schematically showing a configuration of the machine learning apparatus of the first embodiment;

FIG. 5 is a block diagram schematically showing a configuration of a moving object of the first embodiment;

FIG. 6 is a block diagram schematically showing a configuration of the training data creation apparatus of the second embodiment;

FIG. 7 is a plan view schematically showing a configuration of the light detection layer of the polarization image sensor;

FIG. 8 is a plan view schematically showing a configuration of the polarizer layer of the polarization image sensor;

FIG. 9 is a plan view schematically showing a configuration of the microlens layer of the polarization image sensor;

FIG. 10 shows an example of a method to derive a motion vector from an RGB image;

FIG. 11 shows an example of a process to generate a synthetic polarization image performed by the enhancement processing unit; and

FIG. 12 shows an example of a method to derive a motion vector from a synthetic polarization image.

### DETAILED DESCRIPTION

The invention will now be described by reference to the preferred embodiments. This does not intend to limit the scope of the present invention, but to exemplify the invention.

A description will be given of an embodiment to practice the present disclosure with reference to the drawings. The numerals are used in the description to denote the same elements and a duplicate description is omitted as appropriate.

### First Embodiment

In the first embodiment, a motion vector is derived by using direct VSLAM that uses brightness matching. We have noted that brightness matching is difficult when the subject is a flat object such as a wall, but, in a situation where the camera is moving such as that of VSLAM, a certain minute change often appears in an RGB image. For example, a slight change in brightness due to reflection of light on the wall can occur in an RGB image. In this background, deep learning is performed to infer a more accurate motion vector based on such a minute change in an RGB image.

In the first embodiment, the model is trained by machine learning based on RGB images in the event of a lost location and a training motion vector derived from a distance image corresponding to those RGB images. After the training is completed, motion vectors are successively derived from RGB image captured in a time series by using the direct VSLAM algorithm. When the motion vector satisfies a condition for a lost location, a motion vector is inferred based on the RGB images in the event of the lost location, by using the trained model.

Hereinafter, a description will be given in the order: (1) creation of training data, (2) machine-training of model, and (3) inference of motion vector.

### (1) Creation of Training Data

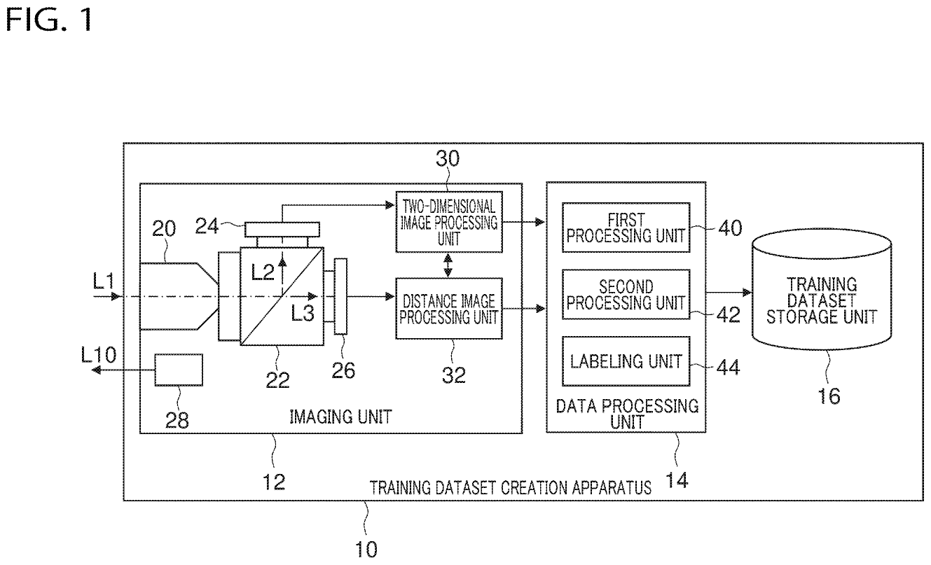

FIG. 1 is a block diagram schematically showing a configuration of a training data creation apparatus 10 according to the first embodiment. The training data creation apparatus 10 captures an image and creates a training dataset for machine-training a model based on the captured image. The training data creation apparatus 10 may be mounted on a moving object (not shown) and may capture images and create a training dataset while the moving object is moving. The training data creation apparatus 10 may be configured to be portable and may capture images and create a training dataset while a person is moving the training data creation apparatus 10.

The training data creation apparatus 10 is equipped with an imaging unit 12, a data processing unit 14, and a training dataset storage unit 16.

The imaging unit 12 is a camera. The imaging unit 12 is equipped with an imaging lens 20, a light splitting element 22, a two-dimensional image sensor 24, a distance image sensor 26, an illumination apparatus 28, a two-dimensional image processing unit 30, and a distance image processing unit 32. The two-dimensional image sensor 24 represents the first image sensor in the present disclosure. The distance image sensor 26 represents the second image sensor in the present disclosure. The second image sensor is an image sensor of a type different from that of the first image sensor, i.e., an image sensor of an imaging principle different from that of the first image sensor.

The light splitting element 22 is placed in a stage that follows the imaging lens 20. The light splitting element 22 splits an incident light L1 passing through the imaging lens 20 into a visible light L2 and an infrared light L3. The visible light L2 is incident on the two-dimensional image sensor 24, and the infrared light L3 is incident on the distance image sensor 26. The light splitting element 22 is, for example, a dichroic prism and is equipped with a dichroic mirror that reflects the visible light L2 selectively and transmits the infrared light L3 selectively. The dichroic mirrors is comprised of, for example, a dielectric multilayer film. The light splitting element 22 may be configured to transmit visible light selectively and reflect infrared light selectively. In this case, the arrangement of the two-dimensional image sensor 24 and the distance image sensor 26 is reversed.

The two-dimensional image sensor 24 images the visible light L2 split by the light splitting element 22. The distance image sensor 26 images the infrared light L3 split by the light splitting element 22. The two-dimensional image sensor 24 and the distance image sensor 26 are arranged in such a way that they are on the same optical axis with reference to the optical axis of the incident light L1. In other words, the image captured by the two-dimensional image sensor 24 and the image captured by the distance image sensor 26 are captured on the same optical axis. The imaging lens 20 is arranged to form an image of the incident light L1 on the respective light-receiving surfaces of the two-dimensional image sensor 24 and the distance image sensor 26.

For example, the frame rate of the two-dimensional image sensor 24 is equal to the frame rate of the distance image sensor 26. The two-dimensional image sensor 24 and the distance image sensor 26 are synchronized to capture images. The timing of start of imaging of a single frame of the two-dimensional image sensor 24 and the timing of start of imaging of a single frame of the distance image sensor 26 are the same. In a given frame, therefore, the image captured by the two-dimensional image sensor 24 and the image captured by the distance image sensor 26 are images of the subject in the same imaging range viewed from the same direction.

The two-dimensional image sensor 24 is equipped with multiple pixels for imaging the visible light L2. The two-dimensional image sensor 24 includes, for example, a CCD (Charge Coupled Devices) sensor, a CMOS (Complementary Metal Oxide Semiconductor) sensor or the like. The two-dimensional image sensor 24 has a color filter, captures a color image, and outputs an RGB image signal. The two-dimensional image sensor 24 can also be referred to as an RGB image sensor. The two-dimensional image sensor 24 may be a monochrome image sensor that does not have a color filter and captures a monochrome image.

The two-dimensional image processing unit 30 acquires the RGB image signal from the two-dimensional image sensor 24. The RGB image signal is, for example, serial data for pixel values of respective pixels, which are read out in order of address of the respective pixels of the two-dimensional image sensor 24. The two-dimensional image processing unit 30 generates an RGB image of each frame from the acquired RGB image signal and supplies data for the RGB image of each frame thus generated to the data processing unit 14. The RGB image can also be referred to as a two-dimensional image. The RGB image represents the first training image in the present disclosure.

The distance image sensor 26 detects a reflected light of an infrared illumination light L10 emitted by the illumination apparatus 28 toward the subject. The distance image sensor 26 is equipped with multiple pixels provided with an infrared light filter that transmits infrared light selectively. The distance image sensor 26 is, for example, a LIDAR (Light Detection And Ranging) sensor and measures a distance to the subject according to the Time of Flight (ToF) scheme. The distance image sensor 26 outputs, for example, serial data for the distance value detected by each pixel as a distance image signal.

The illumination apparatus 28 emits the infrared illumination light L10 toward the subject. The illumination apparatus 28 is equipped with a laser diode array such as a VCSEL (Vertical Cavity Surface Emitting Laser). The illumination apparatus 28 emits a pulsed illumination light.

The distance image processing unit 32 acquires the distance image signal from the distance image sensor 26. The distance image processing unit 32 uses the distance image signal as an input to generate a distance image in which the distance value detected by each pixel of the distance image sensor 26 is defined as the image level.

The distance image processing unit 32 associates the distance image with the RGB image frame by frame. In other words, the distance image processing unit 32 performs association so that the distance image and RGB image with the same timing of start of imaging can be identified. The distance image processing unit 32 supplies data for the distance image of each frame thus generated to the data processing unit 14. The distance image represents the second training image in the present disclosure.

The data processing unit 14 processes the data for the RGB image and the distance image and creates training data for learning. The data processing unit 14 has a first processing unit 40, a second processing unit 42, and a labeling unit 44.

Each block shown in the block diagram of the present disclosure is implemented in hardware such as a CPU, a memory, or other LSI's of an arbitrary computer, and in software such as a program loaded into a memory, etc. The figure depicts functional blocks implemented by the coordination of these elements. Therefore, it will be understood by those skilled in the art that the functional blocks may be implemented in a variety of manners by hardware only, software only, or by a combination of hardware and software.

Some of the plurality of function blocks shown in the block diagram of the present disclosure may be implemented by a computer program. The computer program may be stored in a recording medium, and the computer program may be installed in a computer via the recording medium. Further, the computer program may be downloaded via a communication network and installed in a computer. The CPU of the computer may exhibit the function of each function block by reading the computer program into the main memory and executing the computer program.

The first processing unit 40 receives the data for the RGB image of each frame in a time series and derives a three-dimensional motion vector successively by using a part of the direct SLAM algorithm, based on the RGB image of the latest frame and the RGB image one frame before the latest frame. In other words, the first processing unit 40 derives one motion vector every time the first processing unit 40 receives the RGB image of the latest frame. Any of various known technologies can be used as the direct SLAM. An example of using LSD-SLAM (Large-Scale Direct Monocular SLAM) will be described below. A motion vector, which can also be referred to as a movement vector, represents a change in orientation and amount of movement of the imaging unit 12 from the time the RGB image of the previous frame is captured to the time when the RGB image of the latest frame is captured.

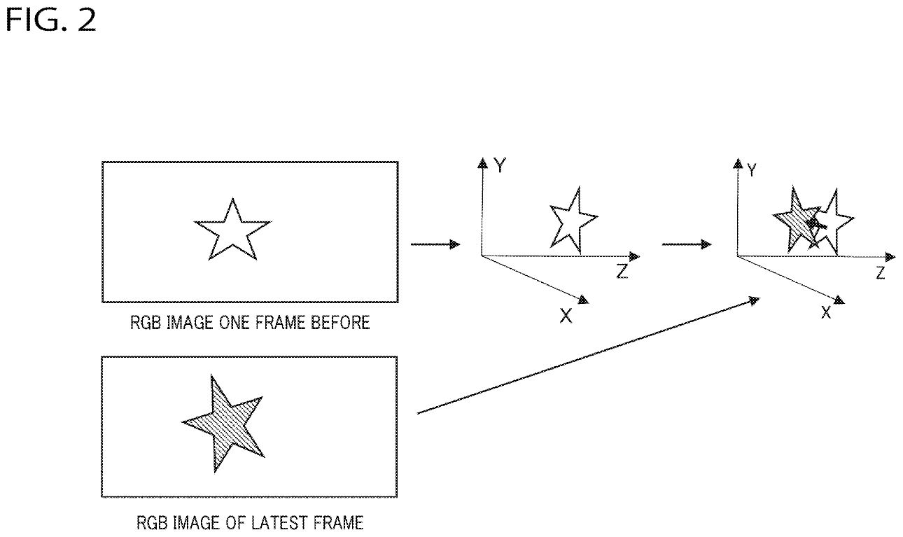

FIG. 2 shows an example of a method to derive a motion vector from RGB images. LSD-SLAM is a matching technology that uses the RGB image of the latest frame as a reference, rotates the RGB image one frame before around the X, Y, and Z axes, respectively, in a three-dimensional space, reduces or enlarges the image along the Z axis to result in an image equivalent to and having the same brightness as the reference RGB image.

As shown in FIG. 2, the first processing unit 40 sets the coordinates of the RGB image one frame before as a three-dimensional image in a three-dimensional space. The first processing unit 40 uses the gradient method to rotate the three-dimensional image of the RGB image one frame before by an angle xad around the X axis in a three-dimensional space, rotate the image by an angle yad around the Y axis, rotate the image by an angle zad around the Z axis, and move the image by a distance da in the Z axis direction so that the three-dimensional image of the RGB image one frame before is equivalent to the three-dimensional image of the RGB image of the latest frame. Ideally, the image resulting from re-projecting the three-dimensional image thus rotated and moved to the two dimensions is the same as the RGB image of the latest frame. A vector representing the rotation by the angle xad, the angle yad, and the angle zad as well as the movement by the distance da is defined to be the motion vector.

Brightness matching is performed in this way so that a matching error occurs easily in a subject such as a wall with little brightness change. If a matching error occurs, an inaccurate motion vector is acquired.

Reference is made back to FIG. 1. The first processing unit 40 determines, every time a motion vector is derived, whether the derived motion vector satisfies a prescribed condition regarding an abnormality in a motion vector. This determination process is a known process in LSD-SLAM. The prescribed condition regarding an abnormality can also be referred to as a condition for a lost location, which is a known condition for determination in LSD-SLAM.

Given that the imaging unit 12 is moving at a speed of 1 m per second, for example, the prescribed condition regarding an abnormality may be satisfied when a motion vector indicating an abrupt jump of 10 m ahead is obtained. In the case the RGB image is an image of a flat wall and the brightness of the pixels in the RGB image is uniform, for example, it is difficult to find a match in brightness between RGB images by LSD-SLAM, and an abnormally large motion vector may be derived. An RGB image like this can also be referred to as a textureless RGB image.

The first processing unit 40 notifies the second processing unit 42 and the labeling unit 44 of an abnormality in the motion vector, i.e., occurrence of a lost location, when the prescribed condition is satisfied, and supplies the motion vector that satisfies the prescribed condition and the data for the RGB images of two frames used to derive the motion vector to the labeling unit 44.

The first processing unit 40 does not supply the motion vector, etc. to the labeling unit 44 when the prescribed condition is not satisfied, i.e., when the motion vector is normal and a lost location has not occurred.

The second processing unit 42 receives the data for the distance image of each frame in a time series. When notified of an abnormality in the motion vector, the second processing unit 42 derives a three-dimensional motion vector as a training motion vector by using a part of the known Depth-SLAM algorithm, based on the distance image of the latest frame and the distance image one frame before the latest frame. These distance images of the two frames used to derive the training motion vector are distance images captured at the same point of time as the RGB images of the two frames used to derive the motion vector that satisfies the prescribed condition.

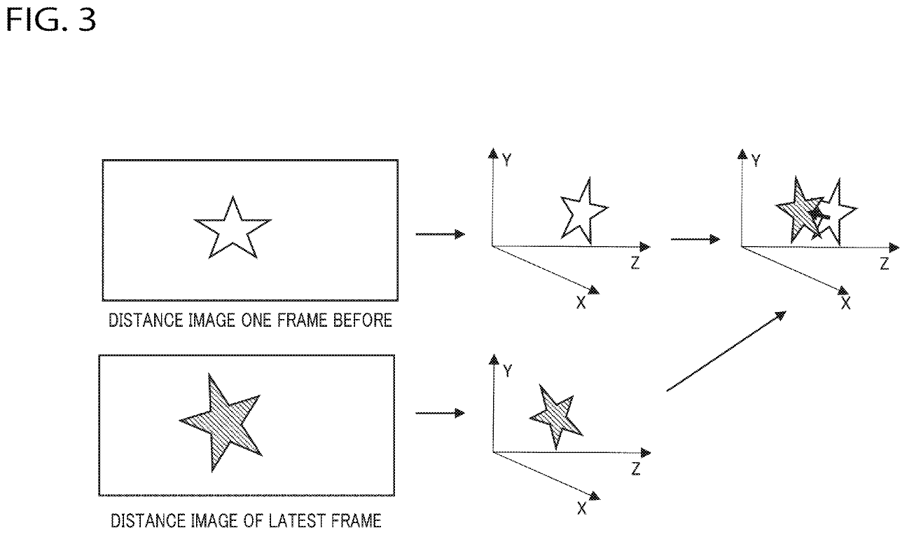

FIG. 3 shows an example of a method to derive a motion vector from a distance image. As shown in FIG. 3, the second processing unit 42 converts the distance image of the latest frame and the distance image one frame before into point clouds and sets the coordinates thereof as three-dimensional images in a three-dimensional space. The second processing unit 42 rotates the point cloud of the distance image one frame before by an angle xbd around the X axis in the three-dimensional space, rotates the point cloud by an angle ybd around the Y axis, rotates the point cloud by an angle zbd around the Z axis, moves the point cloud by a distance db in the Z axis direction to bring the point cloud closer to the point cloud of the distance image of the latest frame. A vector representing the rotation by the angle xbd, the angle ybd, and the angle zbd and the movement by the distance db is defined to be the motion vector.

Even if a major portion of the RGB image is an image of a flat wall, and the brightness of the pixels in the RGB image is uniform, for example, the concurrent distance image includes distance information on each position so that a more accurate motion vector can be derived from the distance image.

Reference is made back to FIG. 1. The second processing unit 42 supplies the derived training motion vector and the data for the distance images of the two frames used to derive the training motion vector to the labeling unit 44.

For example, the second processing unit 42 does not derive a motion vector until the second processing unit 42 is notified of an abnormality in the motion vector. The second processing unit 42 derives a motion vector every time the second processing unit 42 is notified of an abnormality in the motion vector.

When notified of an abnormality in the motion vector, the labeling unit 44 assigns the training motion vector received from the second processing unit 42 as a correct label to the RGB images of the two frames received from the first processing unit 40. The labeling unit 44 stores the data for the RGB images of the two frames, to which the correct label has been assigned, as one set of training data in the training dataset storage unit 16.

The labeling unit 44 may store the data for the RGB images of the two frames, to which the correct label has been assigned, in the training dataset storage unit 16, associating the data with the motion vector received from the first processing unit 40 and satisfying the prescribed condition and with the data for the distance images of the two frames received from the second processing unit 42. The motion vector satisfying the prescribed condition and the data for the distance images of the two frames used to derive the training motion vector are not directly used to train the model described later but can be used by a person to verify the learning situation during training.

In this way, the training data creation apparatus 10 can create, while imaging various subjects, a training dataset by collecting the RGB images of the two frames occurring when the motion vector derived from RGB images of the two frames indicates a lost location and collecting the training motion vector derived from the concurrent distance images of the two frames. Therefore, it is easy to collect a set of the RGB images occurring in the event of a lost location and the concurrent training motion vector that is likely to be accurate. Once the training data including a large number of sets is created, the model is then trained by machine learning.

### (2) Machine-Training of Model

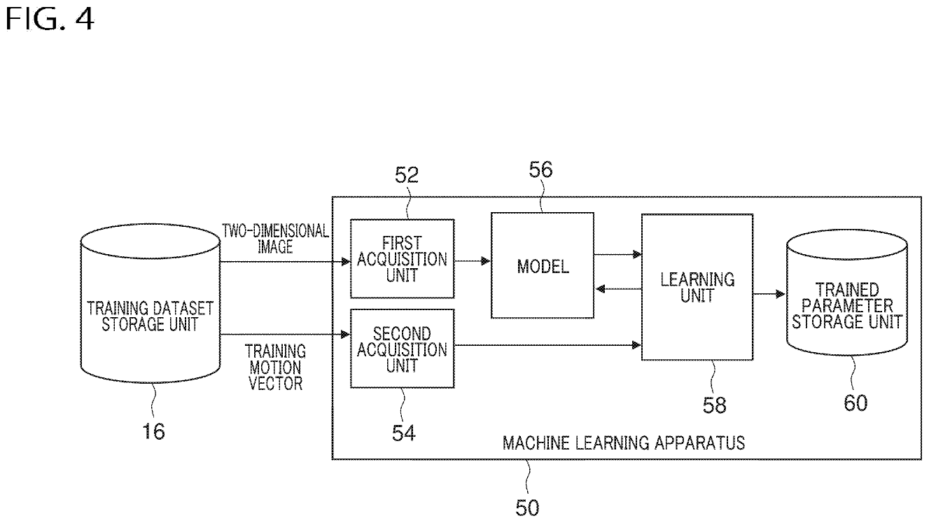

FIG. 4 is a block diagram schematically showing a configuration of the machine learning apparatus 50 of the first embodiment. The machine learning apparatus 50 is equipped with a first acquisition unit 52, a second acquisition unit 54, a model 56, a learning unit 58, and a trained parameter storage unit 60.

The first acquisition unit 52 acquires, under the control of the learning unit 58, the data for the RGB images of the two frames included in one set of training data from the training dataset storage unit 16 that stores the training dataset. The first acquisition unit 52 supplies, under the control of the learning unit 58, the acquired the data for the RGB images of the two frames as training data to the model 56.

The second acquisition unit 54 acquires, from the training dataset storage unit 16 under the control of the learning unit 58, the training motion vector assigned as a correct label to the RGB images of the two frames acquired by the first acquisition unit 52. The second acquisition unit 54 supplies the acquired training motion vector to the learning unit 58 as a correct label.

The model 56 receives the RGB images of the two frames as an input and outputs a vector. The model 56 includes a neural network. Since a known configuration can be used for the neural network, a detailed explanation thereof will be omitted.

The learning unit 58 receives the RGB images of the two frames thus acquired as an input, and trains the model 56 through deep learning using the training motion vector thus acquired as a correct label. The learning unit 58 inputs the data for the RGB images of the two frames to the input layer of the model 56 and adjusts the internal parameters of the model 56 based on the error backpropagation method or the like so that the vector output from the output layer of the model 56 approaches the correct training motion vector. The internal parameters of the model 56 include weights and biases. The learning unit 58 stores the adjusted internal parameters in the trained parameter storage unit 60.

The learning unit 58 improves the inference accuracy of the model 56 by repeatedly training the internal parameters of the model 56 by using various training data stored in the training dataset storage unit 16. The internal parameters stored in the trained parameter storage unit 60 are updated every time the training is performed.

Thus, even if it is not possible to derive an accurate motion vector based on textureless RGB images, a more accurate motion vector can be derived based on the distance images corresponding to those RGB images. Therefore, by training the model 56 using textureless RGB images of two frames as an input, and the training motion vector derived from the corresponding distance images of the two frames as a correct vector, it is possible to create the model 56 capable of inferring a more accurate motion vector from the same RGB images, even if it is not possible to derive an accurate motion vector from the textureless RGB images.

### (3) Motion Vector Inference

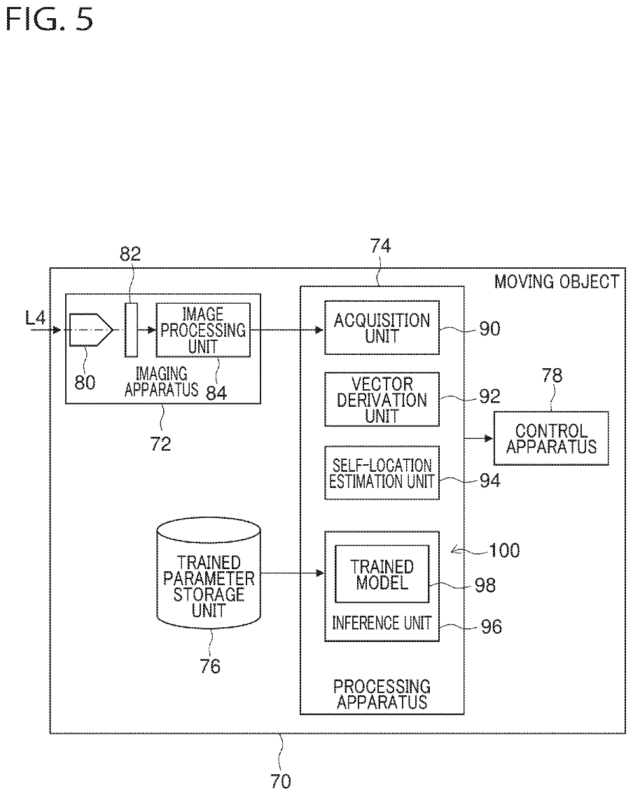

FIG. 5 is a block diagram schematically showing a configuration of a moving object 70 of the first embodiment. The moving object 70 is, for example, a robot capable of autonomous movement. The moving object 70 is equipped with an imaging apparatus 72, a processing apparatus 74, a trained parameter storage unit 76, and a control apparatus 78.

The imaging apparatus 72 has an imaging lens 80, a two-dimensional image sensor 82, and an image processing unit 84. The imaging lens 80 is arranged to form an image of an incident light L4 on the light-receiving surface of the two-dimensional image sensor 82.

The two-dimensional image sensor 82 images the incident light L4 passing through the imaging lens 80. The two-dimensional image sensor 82 is an image sensor of the same type as the two-dimensional image sensor 24 of the training data creation apparatus 10 and has the same function as the two-dimensional image sensor 24. The two-dimensional image sensor 82 is described herein as an RGB image sensor by way of example but may also be a monochrome sensor. The two-dimensional image sensor 82 corresponds to the first image sensor in the present disclosure.

The image processing unit 84 has the same function as the two-dimensional image processing unit 30 of the training data creation apparatus 10. The image processing unit 84 acquires an RGB image signal from a two-dimensional image sensor 82, generates an RGB image of each frame from the acquired RGB image signal, and supplies data for the RGB image of each frame thus generated to the processing apparatus 74.

The moving object 70 has only one two-dimensional image sensor 82 to acquire images for SLAM processing. Therefore, it is easier to reduce the cost of the moving object 70 than in a configuration equipped with a distance image sensor, etc.

The processing apparatus 74 performs the LSD-SLAM process and infers the motion vector by using the trained model in the event of a lost location. The processing apparatus 74 has an acquisition unit 90, a vector derivation unit 92, a self-location estimation unit 94, and an inference unit 96.

The acquisition unit 90 acquires the data for the RGB image of each frame from the image processing unit 84 in a time series and supplies the data for the acquired RGB image to the vector derivation unit 92 and the inference unit 96 in a time series.

The vector derivation unit 92 receives the data for the RGB image of each frame from the acquisition unit 90 in a time series and derives the three-dimensional motion vector in a time series by using a part of the LSD-SLAM algorithm, based on the RGB image of the latest frame and the RGB image one frame before the latest frame.

The vector derivation unit 92 determines, every time a motion vector is derived, whether the derived motion vector satisfies a prescribed condition regarding an abnormality in the motion vector. The prescribed condition regarding an abnormality is the same as the prescribed condition in the training data creation apparatus 10.

The vector derivation unit 92 supplies the derived motion vector to the self-location estimation unit 94 when the prescribed condition is not satisfied. The vector derivation unit 92 notifies the inference unit 96 of the abnormality in the motion vector when the prescribed condition is satisfied and does not supply the derived motion vector to the self-location estimation unit 94.

The trained parameter storage unit 76 stores the trained parameter trained by the machine learning apparatus 50 as described above.

The inference unit 96 applies the trained parameter acquired from the trained parameter storage unit 76 to the neural network to construct a trained model 98. In other words, the trained model 98 is trained by machine learning based on: the RGB images of the two frames of the subject captured by the two-dimensional image sensor 24 of the same type as the two-dimensional image sensor 82; and the three-dimensional training motion vector derived based on the distance images of the two frames of the subject captured by the distance image sensor 26 of a type different from the two-dimensional image sensor 82.

When notified of an abnormality in the motion vector, the inference unit 96 uses the trained model 98 to infer a three-dimensional motion vector based on the RGB images of the two frames acquired by the acquisition unit 90. These RGB images of the two frames are RGB images of the two frames used to derive the motion vector that satisfies the prescribed condition. In other words, these RGB images of the two frames are the RGB image of the latest frame and the RGB image one frame before the latest frame.

The trained model 98 receives the data for the RGB images of the two frames in its input layer and outputs a motion vector from its output layer. The inference unit 96 supplies the inferred motion vector to the self-location estimation unit 94. The inference unit 96 does not infer a motion vector until the inference unit 96 is notified of an abnormality in the motion vector. The inference unit 96 infers a motion vector every time the inference unit 96 is notified of an abnormality in the motion vector. In the case the inference unit 96 is notified of an abnormality in the motion vector in succession, therefore, the inference unit 96 infers a motion vector repeatedly. The acquisition unit 90 and the inference unit 96 constitute the inference apparatus 100.

The self-location estimation unit 94 uses the known LSD-SLAM algorithm to estimate the self-location in real time and create a map based on the motion vector supplied from the vector derivation unit 92 or the inference unit 96.

In other words, in the case the prescribed condition is not satisfied, the self-location estimation unit 94 estimates the self-location based on the motion vector derived by the vector derivation unit 92, and, in the case the prescribed condition is satisfied, the self-location estimation unit 94 estimates the self-location based on the motion vector inferred by the inference unit 96.

The control apparatus 78 uses a known technology to derive a planned moving path based on the self-location estimated by the self-location estimation unit 94 and moves the moving object 70 along the planned moving path thus derived by driving an actuator (not shown). The actuator includes, for example, a servo motor for rotating wheels.

Thus, even if it is not possible to acquire an accurate motion vector from textureless RGB images, a more accurate motion vector can be inferred from those RGB images by using the trained model 98. Therefore, the occurrence of a lost location can be suppressed in the moving object 70 equipped with the inference apparatus 100.

### Second Embodiment

In the second embodiment, a motion vector is derived by using VSLAM, a feature point-based non-direct method. In this case, it is difficult to extract a feature point in the case a flat and unpatterned surface such as a wall is imaged, and so a lost location occurs easily. Increasing the contrast of the RGB image to highlight a small scratch on a wall, etc. in order to extract a feature point from the scratch will also increase noise, which makes it easy to acquire a false motion vector.

In the second embodiment, therefore, the model is trained by machine learning based on the RGB images in the event of a lost location and a training motion vector derived from polarization images corresponding to the RGB images. After the training is completed, the motion vector is derived successively from the RGB images captured in a time series by using the non-direct VSLAM algorithm, and, when the motion vector satisfies the condition for a lost location, the trained model is used to infer a motion vector based on the RGB images at the time of a lost location. Hereinafter, the difference from the first embodiment will mainly be described.

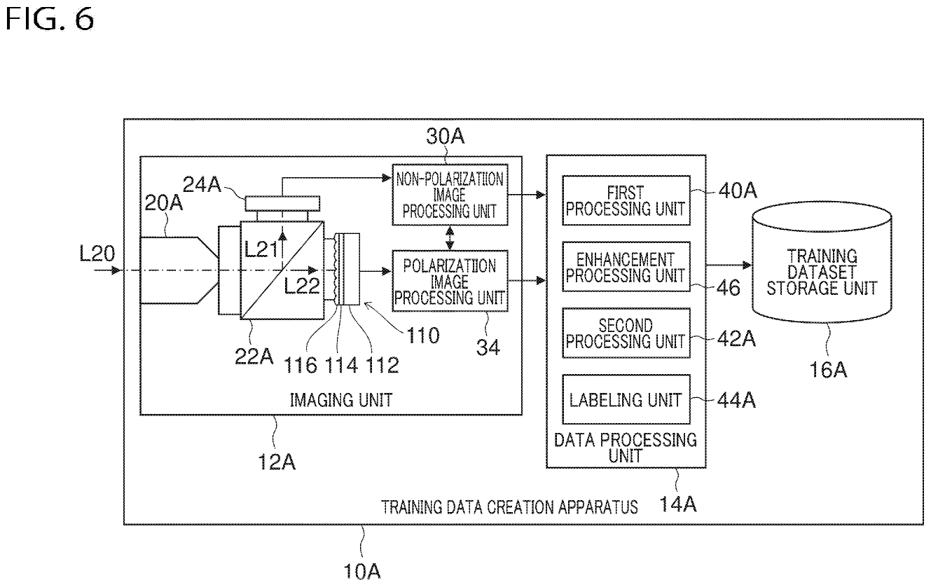

First, a description will be given of creation of training data. FIG. 6 is a block diagram schematically showing a configuration of a training data creation apparatus 10A of the second embodiment. The training data creation apparatus 10A is equipped with an imaging unit 12A, a data processing unit 14A, and a training dataset storage unit 16A.

The imaging unit 12A is a camera. The imaging unit 12A is equipped with an imaging lens 20A, a light splitting element 22A, a non-polarization image sensor 24A, a polarization image sensor 110, a non-polarization image processing unit 30A, and a polarization image processing unit 34. The non-polarization image sensor 24A represents the first image sensor in the present disclosure. The polarization image sensor 110 represents the second image sensor in the present disclosure.

The light splitting element 22A is placed in a stage that follows the imaging lens 20A. The light splitting element 22A splits an incident light L20 passing through the imaging lens 20A into a first light L21 and a second light L22. The first light L21 is incident on the non-polarization image sensor 24A, and the second light L22 is incident on the polarization image sensor 110. The light splitting element 22A is, for example, a non-polarization beam splitter that splits the incident light L20 into the first light L21 and the second light L22 at an intensity ratio of 1:1. The partially reflective surface of the light splitting element 22A is comprised of a half-mirror made of, for example, a thin metal film.

The non-polarization image sensor 24A images the first light L21 split by the light splitting element 22A. The polarization image sensor 110 images the second light L22 split by the light splitting element 22A. The non-polarization image sensor 24A and the polarization image sensor 110 are arranged in such a way that they are on the same optical axis with reference to the optical axis of the incident light L20. In other words, the image captured by the non-polarization image sensor 24A and the image captured by the polarization image sensor 110 are captured on the same optical axis. The imaging lens 20A is arranged to form an image of the incident light L20 on the respective light-receiving surfaces of the non-polarization image sensor 24A and the polarization image sensor 110.

For example, the frame rate of the non-polarization image sensor 24A is equal to the frame rate of the polarization image sensor 110. The non-polarization image sensor 24A and the polarization image sensor 110 are synchronized to capture images. The timing of start of imaging of a single frame of the non-polarization image sensor 24A and the timing of start of imaging of a single frame of the polarization image sensor 110 are the same. In a given frame, therefore, the image captured by the non-polarization image sensor 24A and the image captured by the distance image sensor 26 are images of the subject in the same imaging range viewed from the same direction.

The non-polarization image sensor 24A has the same function as the two-dimensional image sensor 24 of the first embodiment. The non-polarization image processing unit 30A has the same function as the two-dimensional image processing unit 30 of the first embodiment. In other words, the non-polarization image processing unit 30A generates an RGB image of each frame based on an RGB image signal acquired from the non-polarization image sensor 24A. The non-polarization image processing unit 30A supplies the data for the RGB image of each frame thus generated to the data processing unit 14A. The RGB image can also be said to be a non-polarization image. The RGB image represents the first training image in the present disclosure.

The polarization image sensor 110 simultaneously captures four polarization images with different polarization directions as a polarization image of one frame. The polarization image sensor 110 is equipped with multiple pixels for imaging the incident light L20. The polarization image sensor 110 is equipped with a light detection layer 112, a polarizer layer 114, and a microlens layer 116. The light detection layer 112, the polarizer layer 114, and the microlens layer 116 are arranged in such a way that they overlap in the direction of incidence of the incident light L20. In the example of FIG. 6, the microlens layer 116, the polarizer layer 114, and the light detection layer 112 are arranged in that order, starting from the side of the light splitting element 22A. The polarization image sensor 110 differs from the non-polarization image sensor 24A in that the polarization image sensor 110 is equipped with the polarizer layer 114 and is not equipped with a color filter.

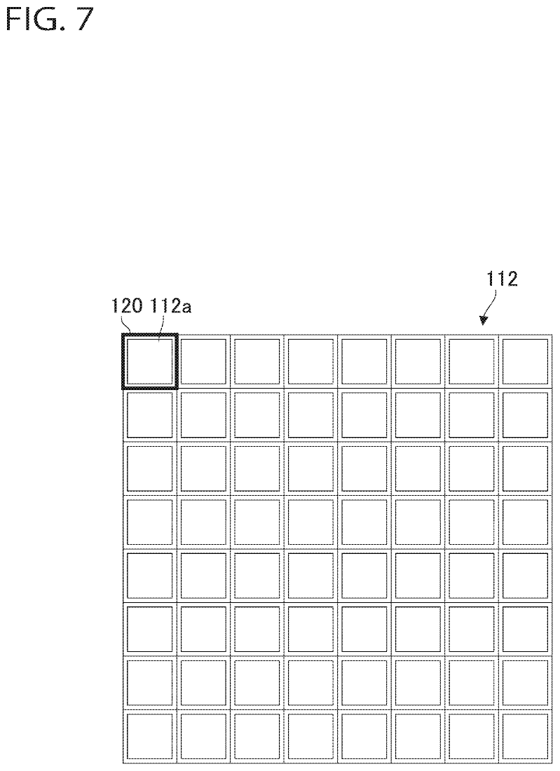

FIG. 7 is a plan view schematically showing a configuration of the light detection layer 112 of the polarization image sensor 110. The light detection layer 112 is, for example, configured similarly to a two-dimensional image sensor such as a CCD sensor and a CMOS sensor. The light detection layer 112 is equipped with a photodiode 112a for detecting the incident light L20 and converting the incident light L20 into an electrical signal. The light detection layer 112 is equipped with multiple photodiode 112a that are arranged in two dimensions. The light detection layer 112 is, for example, equipped with one photodiode 112A for each pixel 120 of the polarization image sensor 110.

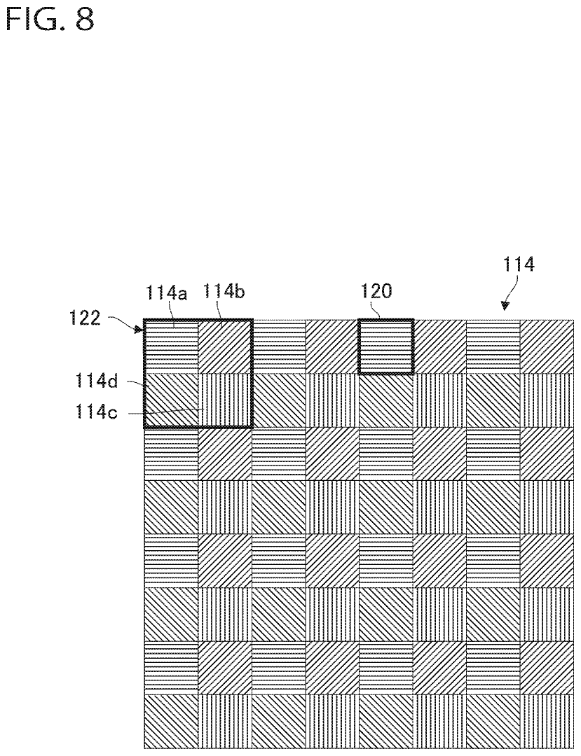

FIG. 8 is a plan view schematically showing a configuration of the polarizer layer 114 of the polarization image sensor 110. The polarizer layer 114 is equipped with a first polarizer 114a, a second polarizer 114b, a third polarizer 114c, and a fourth polarizer 114d for detecting polarization components that differ from one pixel 120 to another. In other words, one of the four polarizers 114a-114d is provided for one pixel 120. The first polarizer 114a selectively transmits the first polarization component, which is a linear polarization in the first direction. The first direction is, for example, a horizontal or 0-degree direction. The second polarizer 114b selectively transmits the second polarization component, which is a linear polarization in the second direction. The second direction is, for example, a diagonally right or 45-degree direction. The third polarizer 114c selectively transmits the third polarization component, which is a linear polarization in the third direction. The third direction is, for example, a vertical or 90-degree direction. The fourth polarizer 114d selectively transmits the fourth polarization component, which is a linear polarization in the fourth direction. The fourth direction is, for example, a diagonally left or 135-degree direction. The polarizers 114a-114d are, for example, wire grid polarizers.

The polarizer layer 114 has a structure in which a pixel group 122 including four pixels arranged in a 2×2 array is arranged in two dimensions as a repeating unit. One pixel group 122 is equipped with a first pixel provided with the first polarizer 114a, a second pixel provided with the second polarizer 114b, a third pixel provided with the third polarizer 114c, and a fourth pixel provided with the fourth polarizer 114d. The first polarizer 114a and the third polarizer 114c are provided in diagonally situated pixels in one pixel group 122. The second polarizer 114b and the fourth polarizer 114d are provided in diagonally situated pixels in one pixel group 122. Each of the four polarizers 114a-114d is arranged in every other pixel vertically and horizontally in two dimensions.

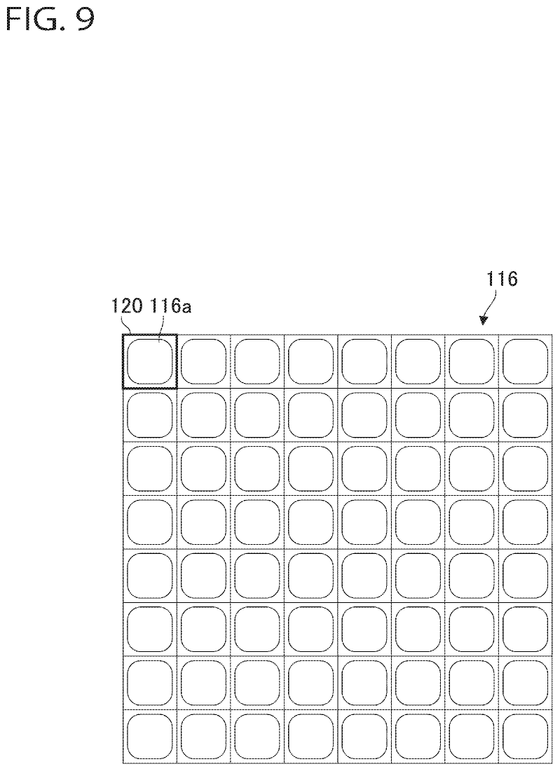

FIG. 9 is a plan view schematically showing a configuration of the microlens layer 116 of the polarization image sensor 110. The microlens layer 116 has multiple microlenses 116a that are arranged in two dimensions. The microlens layer 116 is equipped with, for example, one microlens 116a for each pixel 120 of the polarization image sensor 110.

Reference is made back to FIG. 6. The polarization image processing unit 34 acquires a polarization image signal output from the polarization image sensor 110. The polarization image signal corresponds to raw data output from the polarization image sensor 110 and is, for example, serial data for the pixel value of each pixel 120 read out in order of address of the pixels 120 of the polarization image sensor 110.

The polarization image processing unit 34 generates an image of each of the four polarization components as a captured polarization image from the polarization image signal for one frame thus acquired. The polarization image processing unit 34 separates, per polarization component, the pixel values included in the polarization image signal of one frame to generate four captured polarization images corresponding to the four polarization components. The polarization image processing unit 34 generates four captured polarization images corresponding to the four polarization components per frame. In other words, the polarization image sensor 110 can be said to simultaneously capture four captured polarization images per frame. Each of the four captured polarization images has an equal number of pixels. A polarization image of one frame includes four captured polarization images. A polarization image of one frame represents the second training image in the present disclosure.

The polarization image processing unit 34 associates the four captured polarization images with the RGB images frame by frame. In other words, the polarization image processing unit 34 performs association so that the four captured polarization images and the RGB images with the same timing of start of imaging can be identified. The polarization image processing unit 34 supplies the data for the four captured polarization images of each frame thus generated to the data processing unit 14A.

The data processing unit 14A processes the data for the RGB image and the polarization image and creates training data for training. The data processing unit 14A includes a first processing unit 40A, an enhancement processing unit 46, a second processing unit 42A, and a labeling unit 44A.

The first processing unit 40A receives the data for the RGB image of each frame in a time series and derives a three-dimensional motion vector successively by using a part of the non-direct SLAM algorithm, based on the RGB image of the latest frame and the RGB image one frame before the latest frame. In other words, the first processing unit 40A derives one motion vector every time the first processing unit 40A receives the RGB image of the latest frame. Any of various known technologies can be used as the non-direct SLAM. Hereinafter, an example of using ORB-SLAM (Oriented FAST and Rotated BRIEF SLAM) will be described.

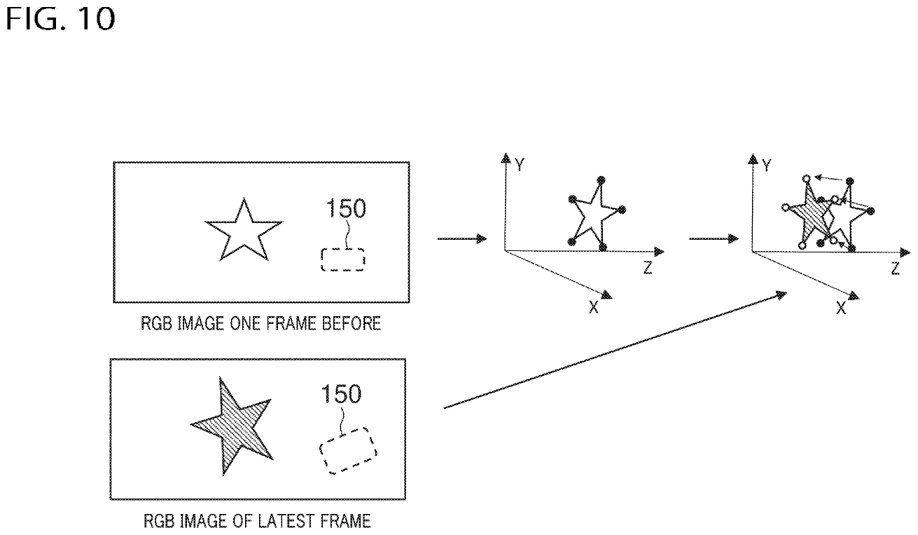

FIG. 10 shows an example of a method to derive a motion vector from an RGB image. As shown in FIG. 10, the first processing unit 40A sets the coordinates of the RGB image one frame before as a three-dimensional image in a three-dimensional space and extracts multiple feature points in the three-dimensional image. In the example shown, a feature point is set at each vertex of the star shape. Meanwhile, an image 150 of a scratch on the wall in the RGB image has low brightness, and so a feature point is not extracted. The first processing unit 40A matches a pair of feature points in the three-dimensional image of the RGB image one frame before with a pair of feature points in the three-dimensional image of the RGB image of the latest frame, and calculates the amount of movement and the direction of movement of the feature points between the frames. Specifically, the first processing unit 40A detects a feature point corresponding to each feature point of the previous frame from the latest frame and calculates the amount of movement and the direction of movement of each feature point between the frames, based on the position of each feature point in the previous frame and the position in the latest frame. Ideally, the image that results from moving the three-dimensional image of the previous frame by the amount of movement and in the direction of movement thus determined and re-projecting the resultant image onto two dimensions is the same as the RGB image of the latest frame. The vector that represents the amount of movement and the direction of movement of the feature point between the frames is defined to be the motion vector.

In this way, matching is performed between feature points, and so a matching error occurs easily in a subject such as a wall with few feature points. When a matching error occurs, an inaccurate motion vector is acquired.

Reference is made back to FIG. 6. The first processing unit 40A determines, every time a motion vector is derived, whether the derived motion vector satisfies the prescribed condition regarding an abnormality in the motion vector. This determination process is a known process in ORB-SLAM. The prescribed condition regarding an abnormality can also be referred to as a lost location condition, which is a known condition for determination in ORB-SLAM.

When the RGB image is an image of a flat and unpatterned wall, for example, it is difficult to extract a feature point from the RGB image by ORB-SLAM, and so an abnormally large motion vector could be derived. Even if there are small scratches on a flat and unpatterned wall, it is difficult to extract an accurate feature point from an image of a scratch because a small scratch is not noticeable in the RGB image. The RGB image like this can also be referred to as a textureless RGB image.

The first processing unit 40A notifies, when the prescribed condition is satisfied, the enhancement processing unit 46, the second processing unit 42A, and the labeling unit 44A of an abnormality in the motion vector, i.e., the occurrence of a lost location and supplies the motion vector satisfying the prescribed condition and the data for the RGB images of the two frames used to derive the motion vector to the labeling unit 44A.

The first processing unit 40A does not supply the motion vector, etc. to the labeling unit 44A when the prescribed condition is not satisfied, i.e., when the motion vector is normal and a lost location has not occurred.

The enhancement processing unit 46 receives data for a set of four captured polarization images that make up the polarization image of each frame in a time series. When notified of an abnormality in the motion vector, the enhancement processing unit 46 generates a synthetic polarization image for each of the two polarization images captured at the same point of time as the RGB images of the two frames used to derive the motion vector satisfying the prescribed condition.

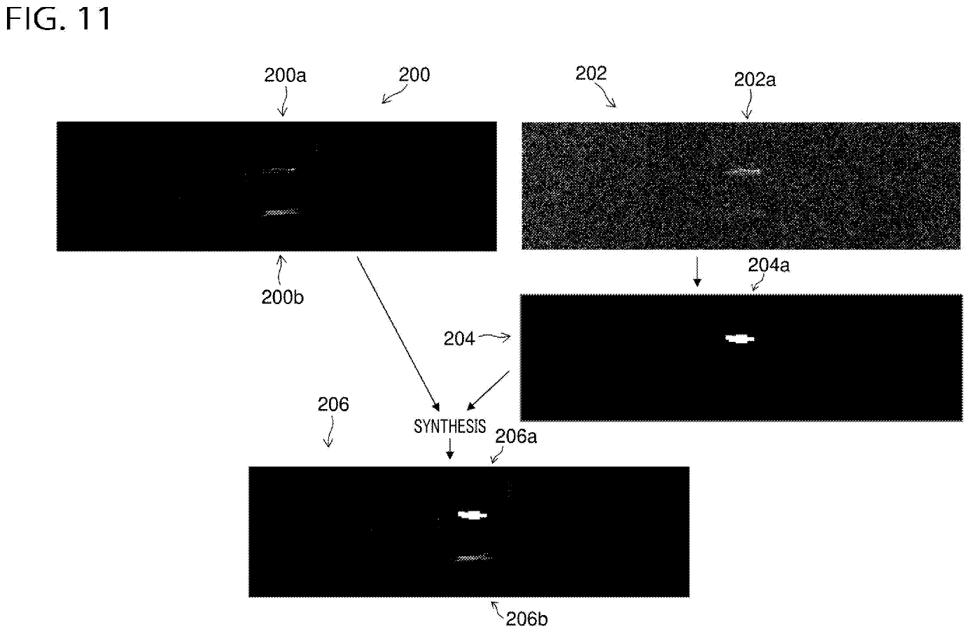

FIG. 11 shows an example of a process to generate a synthetic polarization image performed by the enhancement processing unit 46. A description will be given of an example in which small uneven scratches and small spots of white paint are located on the surface of a flat, unpatterned wall, and the wall is imaged.

The enhancement processing unit 46 generates, for each polarization image of one frame, an average polarization image 200 in which the brightness values are averaged for each pixel of the four captured polarization images of the polarization image. The number of pixels in the average polarization image 200 is equal to the number of pixels in one captured polarization image. The brightness value of the nth (n is a natural number) pixel of the average polarization image 200 is an average of the brightness values of the nth pixel in the four captured polarization images. A known technology can be used to generate the average polarization image 200. The average polarization image 200 includes information on the four polarization components and so is equivalent to an image that results from converting the RGB image into a grayscale image. Therefore, an image 200a of a scratch located on the upper side near the center of the average polarization image 200 is not noticeable, and so it is difficult to detect a feature point. Further, an image 200b of the paint located on the lower side near the center of the average polarization image 200 is more noticeable than the image 200a of a scratch, and so it may be possible to detect a feature point.

Further, the enhancement processing unit 46 generates, for each polarization image of one frame, a linear polarization degree image 202 based on the four captured polarization images of the polarization image. Specifically, the enhancement processing unit 46 derives, for each polarization image of one frame, a degree of linear polarization (DOLP) for each pixel based on the four captured polarization images of the polarization image. The enhancement processing unit 46 generates a linear polarization degree image 202 including a group of pixels having brightness values determined by the degree of linear polarization thus derived. The number of pixels in the linear polarization degree image 202 is equal to the number of pixels in one captured polarization image. A known technology can be used to generate the linear polarization degree image 202.

In the example shown, the larger the degree of linear polarization of the linear polarization degree image 202, the higher the brightness. The image 202a of a scratch located on the upper side near the center is more noticeable than the image 200a of a scratch in the average polarization image 200. Meanwhile, the portion of the paint that is visible in the average polarization image 200 is almost invisible in the linear polarization degree image 202.

Subsequently, the enhancement processing unit 46 generates, for each polarization image of one frame, an enhanced image 204 in which the brightness value of the linear polarization degree image 202 is enhanced. Specifically, the enhancement processing unit 46 divides multiple pixels in the linear polarization degree image 202 into pixel sets each including an 8×8 array of 64 pixels, and for each pixel set, sets the brightness value of each of the 64 pixels in the pixel set to the maximum value if the number of pixels having a degree of linear polarization exceeding a threshold value TH among the 64 pixels is equal to or larger than a predetermined number. The threshold value TH is, for example, 50%. The predetermined number is a natural number and is, for example, 1. The threshold value TH and the predetermined number can be determined as appropriate by an experiment or a simulation. The number of pixels in the pixel set is not limited to 64 and can be determined as appropriate by an experiment or a simulation. In the example shown, an image 204a of a scratch located on the upper side near the center of the enhanced image 204 has the maximum brightness and is more noticeable than the image 202a of a scratch of the linear polarization degree image 202.

Subsequently, the enhancement processing unit 46 generates, for each polarization image of one frame, a synthetic polarization image 206 in which the enhanced image 204 and the average polarization image 200 are synthesized. For example, for each corresponding pixel between the enhanced image 204 and the average polarization image 200, the enhancement processing unit 46 adopts the larger brightness value as the brightness value of that pixel in the synthetic polarization image 206. In the synthetic polarization image 206, therefore, an image 206a of a scratch will be identical to the image 204a of a scratch in the enhanced image 204, and an image 206b of the paint will be identical to the image 200b of the paint in the average polarization image 200, for example. The enhancement processing unit 46 supplies data for the synthetic polarization image 206 thus generated to the second processing unit 42A.

A linear polarization degree image makes scratches, etc. of the subject noticeable, which makes it easier to extract feature points accurately and improve the accuracy of the training motion vector. Also, generating an enhanced image can make scratches, etc. of the subject more noticeable. Further, generating a synthetic polarization image makes it possible to make small spots of paint, etc. that does not easily appear in a linear polarization degree image more noticeable. This makes it possible to extract more feature points and increase the accuracy of the training motion vector.

For example, the enhancement processing unit 46 does not generate a synthetic polarization image until the enhancement processing unit 46 is notified of an abnormality in the motion vector. The enhancement processing unit 46 generates a synthetic polarization image every time the enhancement processing unit 46 is notified of an abnormality in the motion vector.

The second processing unit 42A receives the data for the synthetic polarization images of two frames in a time series. When notified of an abnormality in the motion vector, the second processing unit 42A derives a three-dimensional motion vector as a training motion vector by using a part of the known ORB-SLAM algorithm, based on the synthetic polarization image of the latest frame and the synthetic polarization image one frame before the latest frame. The derivation process for deriving the motion vector performed by the second processing unit 42A is the same as the derivation process for deriving the motion vector performed by the first processing unit 40A. These synthetic polarization degree images of the two frames used to derive the training motion vectors are derived based on polarization images captured at the same time point of time as the RGB images of the two frames used to derive the motion vector satisfying the prescribed condition.

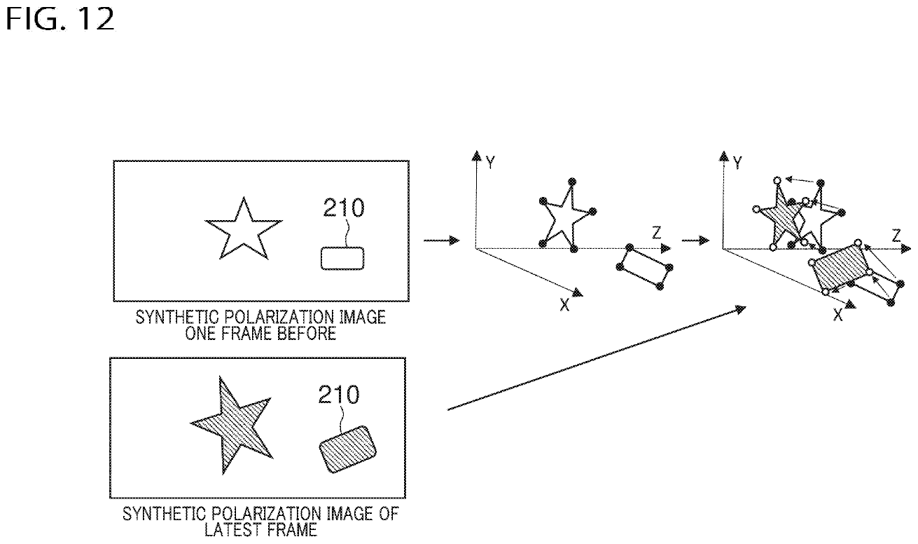

FIG. 12 shows an example of a method to derive a motion vector from a synthetic polarization image. As shown in FIG. 12, the second processing unit 42A sets the coordinates of the synthetic polarization image one frame before as a three-dimensional image in a three-dimensional space and extracts multiple feature points in the three-dimensional image. In the example shown, a feature point is set at each vertex of the star shape. Further, the image 210 of a scratch on the wall in the synthetic polarization image is enhanced and has a high brightness, and so a feature point thereof has been extracted. The second processing unit 42A matches a pair of feature points in the three-dimensional image of the synthetic polarization image one frame before with a pair of feature points in the three-dimensional image of the synthetic polarization image of the latest frame, and calculates the amount of movement and the direction of movement of the feature points between the frames. Ideally, the image that results from moving the three-dimensional image of the previous frame by the amount of movement and in direction of movement thus determined and re-projecting the resultant image onto two dimensions is the same as the synthetic polarization image of the latest frame.

In this way, using a synthetic polarization image can increase the number of feature points such as scratches even in a subject with few feature points such as a wall, which makes it difficult for a matching error to occur. In other words, it is possible to derive a more accurate motion vector.

Reference is made back to FIG. 6. The second processing unit 42A supplies the training motion vector thus derived and the data for the synthetic polarization images of the two frames used to derive the training motion vector to the labeling unit 44A.

For example, the second processing unit 42A does not derive a motion vector until the second processing unit 42A is notified of an abnormality in the motion vector. The second processing unit 42A derives a motion vector every time the second processing unit 42A is notified of an abnormality in the motion vector.

When notified of an abnormality in the motion vector, the labeling unit 44A assigns the training motion vector received from the second processing unit 42A as a correct label to the RGB images of the two frames received from the first processing unit 40A. The labeling unit 44A stores the data for the RGB images of the two frames, to which the correct label has been assigned, as one set of training data in the training dataset storage unit 16A.

The labeling unit 44A may store the data for the RGB images of the two frames, to which the correct label has been assigned, in the training dataset storage unit 16A, associating the data with the motion vector received from the first processing unit 40A and satisfying the prescribed condition and with the data for the synthetic polarization images of the two frames received from the second processing unit 42A. The motion vector satisfying the prescribed condition and the data for the synthesized polarization images of the two frames used to derive the training motion vector are not directly used to train the model but can be used by a person to verify the learning situation during training.

In this way, the training data creation apparatus 10A can create a training dataset by collecting, while imaging various subjects, the two RGB images of the two frames occurring when the motion vector derived from the RGB images of the two frames indicates a lost location and the training motion vector derived from the polarization images of the relevant two frames. Therefore, it is easy to collect a set comprised of RGB images in the event of a lost location and a training motion vector that is likely to be accurate at that time. Once the training data including a large number of sets is created, the model is then machine-learned.

Machine learning of the model is performed by the machine learning apparatus 50 of FIG. 4. The machine learning apparatus 50 performs the learning process in the same way as the first embodiment, except that the training data created by the training data creation apparatus 10A is acquired in place of the training data created by the training data creation apparatus 10 of the first embodiment.

In this way, even if it is not possible to derive an accurate motion vector based on textureless RGB images, a more accurate motion vector can be derived based on polarization images corresponding to those RGB images. Therefore, by training the model 56 using the RGB images of the two frames as an input, and the training motion vector derived from the polarization images of the corresponding two frames as a correct vector, it is possible to create the model 56 capable of inferring a more accurate motion vector from the same RGB images, even if it is not possible to acquire an accurate motion vector from textureless RGB images.

Inference of the motion vector is performed by the inference apparatus 100 of the moving object 70 in FIG. 5. The inference apparatus 100 infers the motion vector in the same way as the first embodiment, except that the inference apparatus 100 uses the trained parameters trained based on the training data created by the training data creation apparatus 10A in place of the trained parameters trained based on the trained data created by the training data creation apparatus 10A of the first embodiment. In other words, the trained model 98 is trained by machine learning based on: non-polarization training images of two frames of the subject imaged by the non-polarization image sensor 24A of the same type as the two-dimensional image sensor 82; and a three-dimensional training motion vector derived based on polarization images of two frames of the subject imaged by the polarization image sensor 110 of a type different from the two-dimensional image sensor 82. In this way, even if it is not possible to derive an accurate motion vector from textureless RGB images, a more accurate motion vector can be inferred from those RGB images.

The vector derivation unit 92 and the self-location estimation unit 94 in the moving object 70 respectively perform the same process as that of the first embodiment by using the ORB-SLAM algorithm in place of LSD-SLAM of the first embodiment. The other processes in the moving object 70 are the same as those of the first embodiment.

Given above is a description of the present disclosure based on the embodiments. The embodiment is intended to be illustrative only and it will be understood by those skilled in the art that various modifications to combinations of constituting elements and processes are possible and that such modifications are also within the scope of the present disclosure.

### First Variation

In the first embodiment, the training data creation apparatus 10 is equipped with the distance image sensor 26 but may be equipped with the polarization image sensor 110 of the second embodiment in place of the distance image sensor 26. In this case, the data processing unit 14 includes the second processing unit 42A of the second embodiment in place of the second processing unit 42 and also includes the enhancement processing unit 46 of the second embodiment. In other words, the training data creation apparatus 10 may, as in the second embodiment, derive the training motion vector based on the polarization image in place of the distance image. In this case, too, the first processing unit 40 derives the motion vector by using the direct SLAM algorithm.

In the second embodiment, the training data creation apparatus 10A is provided with the polarization image sensor 110 but may be equipped with the distance image sensor 26 of the first embodiment in place of the polarization image sensor 110. In this case, the data processing unit 14A includes the second processing unit 42 of the first embodiment in place of the second processing unit 42A and does not include the enhancement processing unit 46. In other words, the training data creation apparatus 10A may, as in the first embodiment, derive the training motion vector based on the distance image in place of the polarization image. In this case, too, the first processing unit 40A derives the motion vector by using the algorithm of the non-direct SLAM.

According to the first variation, the flexibility of the configuration of the training data creation apparatus 10, 10A can be improved.

### Second Variation

In the first embodiment, the training data creation apparatus 10 splits the incident light L1 by using the light splitting element 22 but may not be equipped with the light splitting element 22. In this case, the two-dimensional image sensor 24 and the distance image sensor 26 may be arranged so that the respective light-receiving surfaces are adjacent and the respective light-receiving surfaces are substantially parallel. In this case, too, the two-dimensional image sensor 24 and the distance image sensor 26 are arranged in such a way that they are on the same optical axis. Further, when the number of pixels of the two-dimensional image sensor 24 and that of the distance image sensor 26 are different, multiple pixels of the sensor with a large number of pixels may be mapped to one pixel of the sensor with a smaller number of pixels.

In the second embodiment, the training data creation apparatus 10A splits the incident light L20 by using the light splitting element 22A but may not be equipped with the light splitting element 22A. In this case, the non-polarization image sensor 24A and the polarization image sensor 110 may be arranged in such a way that the respective light-receiving surfaces are adjacent and the respective light-receiving surfaces are substantially parallel. It is assumed that the non-polarization image sensor 24A and the polarization image sensor 110 are arranged on the same optical axis in this case, too. Further, when the number of pixels of the non-polarization image sensor 24A and that of the polarization image sensor 110 are different, multiple pixels of the sensor with a large number of pixels may be mapped to one pixel of the sensor with a smaller number of pixels.

According to the second variation, the flexibility of the configuration of the training data creation apparatus 10, 10A can be improved.

### Third Variation

The training data creation apparatus 10 of the first embodiment may not be equipped with the imaging unit 12. In this case, the imaging unit 12 and a storage apparatus (not shown) are configured to be a camera, and the RGB image and the distance image captured by the imaging unit 12 are stored in the storage apparatus. After the imaging is completed, the training data creation apparatus 10 reads the RGB image and the distance image from the storage apparatus in a time series and performs the training data creation process described above. In other words, the imaging and the training data creation process are not performed in parallel.

Similarly, the training data creation apparatus 10A of the second embodiment may not be equipped with the imaging unit 12A. In this case, the imaging unit 12A and a storage apparatus (not shown) are configured to be a camera, and the RGB image and the polarization image captured by the imaging unit 12A are stored in the storage apparatus. After the imaging is completed, the training data creation apparatus 10A reads the RGB image and the polarization image from the storage apparatus in a time series and performs the training data creation process described above.

According to the third variation, the flexibility of the configuration of the training data creation apparatus 10, 10A can be improved.

### Other Variations

At least two of the first, second, and third variations may be combined.

What is claimed is:

1. A machine learning apparatus comprising:
a first acquisition unit that acquires first training images of two frames of a subject captured by a first image sensor;
a second acquisition unit that acquires a three-dimensional training motion vector derived based on second training images of two frames of the subject captured by a second image sensor of a type different from that of the first image sensor at the same point of time as the first training images of the two frames; and
a learning unit that receives the first training images of the two frames acquired as an input, and trains a model by machine learning using the training motion vector acquired as a correct vector,
wherein the first training images are non-polarization images, and
wherein the second training images are polarization images.

2. The machine learning apparatus according to claim 1,
wherein the first image sensor is a non-polarization image sensor,
wherein the second image sensor is a polarization image sensor,
wherein the polarization image sensor captures a plurality of captured polarization images with different polarization directions as a polarization image of one frame,
wherein, for each polarization image of one frame, an average polarization image in which brightness values are averaged for each pixel of the plurality of captured polarization images of the polarization image is generated, a linear polarization degree image is generated based on the plurality of captured polarization images of the polarization image, and a synthetic polarization image in which the average polarization image and the linear polarization degree image are synthesized is generated, and
wherein the training motion vector is derived based on synthetic polarization images of two frames.

3. The machine learning apparatus according to claim 1,
wherein the first training images and the second training images are captured on the same optical axis.

4. The machine learning apparatus according to claim 1,
wherein the motion vector derived from the first training images of the two frames satisfies a prescribed condition regarding an abnormality in the motion vector.

5. An inference apparatus comprising:
an acquisition unit that acquires images of two frames captured by a first image sensor; and
an inference unit that uses a trained model to infer a three-dimensional motion vector based on the images of the two frames acquired,
wherein the trained model is trained by machine learning based on:
first training images of two frames of a subject captured by an image sensor of the same type as the first image sensor; and
a three-dimensional training motion vector derived based on second training images of two frames of the subject captured by a second image sensor of a type different from that of the first image sensor,
wherein the first training images are non-polarization images, and
wherein the second training images are polarization images.
